(19) United States
(12) Patent Application Publication
(10) Pub. No.: US 2008/0147422 A1
(43) Pub. Date: Jun. 19, 2008

(54) Systems and methods for integrating sports data and processes of sports activities and organizations on a computer network

(76) Inventor: Thomast C. Van Buskirk, Arvada, CO (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/639,910

(22) Filed: Dec. 15, 2006

(51) Int. Cl. G06Q 99/00

(52) U.S. Cl. 705/1

(57) ABSTRACT

A system and methods are described for integrating enterprise resource planning tools in sports activities and organizations. More specifically, the system and methods provide systems and methods for integrating all data and processes of a sports organization and of member players or athletes engaged in physical activities into a unified system on a computer network. Further, the system and methods provides users of the computer network with privileged access to various team and individual data, and further, the ability to communicate and collaborate with other users to achieve individual and organizational goals.

### FIELD OF THE INVENTION

The invention relates generally to providing systems and methods for integrating all data and processes of a sports organization and of member players or athletes engaged in physical activities into a unified system on a computer network. Users of the computer network, including individual athletes, in addition to the staff and professionals of the organization, will have privileged access to various team and individual data, and will have the ability to communicate and collaborate with other users to discuss the data to achieve individual and organizational goals.

### BACKGROUND OF THE INVENTION

Data and statistics tracking has been a part of sports for centuries. With the invention of the computer in the past half-century, several products have attempted to give coaches and players a better understanding of their team's and personal performances by storing this data on computers and allowing the coach or player to query and access this data using some kind of user interface.

While these products have provided some interesting facilities into statistics gathering, they have left out crucial data associated with the team or player has historically gone uncollected. This forgotten data consists of all of the data that can be gathered and monitored outside of the games from all parts of an organization, as well as come crucial data components within the game. These products have also failed to fully integrate the data into a unified system, including multiple components of computer software and hardware.

In view of the above, there is a need for a system and method for integrating sports data and processes of sports activities and organization on a computer network which allow users to review data from all aspects of the organization and further, to communicate and collaborate more effectively.

### BRIEF SUMMARY OF THE INVENTION

The inventions provide a system and methods for communication between players, coaches, and other members affiliated with a sports team or organization to facilitate player and team development and growth. In addition, the inventions described give organizations and team administrators, including coaches, managers, staff, and other personnel, the ability to formulate plans for how to improve their individual athletes, team or entire organization based upon the review and analysis past event data from all aspects of the sporting activity. The inventions also give players the ability to enter and view data about their past performances, injuries, workouts, nutrition, and mental state. Coaches and other personnel will also have the ability to enter data on past performances, injuries, workouts, nutrition, and mental state information. Furthermore, team administrators, coaches, managers and staff will be able to view all this information, and collaborate with their team and players concerning the data input. This information and collaboration allows players to make better assessments as to how to improve their performance and track their achievement in their activity and/or sport.

The inventions further provide a system and methods for data collection outside of the games which may consist of various types of data, including workout data recorded when performed by players at practice (for example: throwing, hitting, and fielding workouts in baseball). This data found outside of game situations are generally forgotten in the overall analysis of player performance and achievement in lieu of game statistical analysis. However, this data is useful in evaluating the personal tendencies of the player and/or his team, in addition to the tendencies of opponents at the individual or team level when scouting the opponents.

The collection of this forgotten data (in conjunction with the typified collection of sports data and statistics) allows players, coaches, managers, general managers, scouts, trainers, and others involved in the team, organization, club, or school to become more consistent and improves individual and team performance.

The inventions described herein aid in the development of player confidence by tracking the player's amount of time and effort put in to improving their game and by facilitating a more interactive and collaborative player-coach relationship. Moreover, the inventions allow those players who gain confidence through their own performance and perseverance to do so by seeing their improvement tracked over time.

More specifically, players are given the capacity to store and retrieve information about their personal physical and mental growth. Having information about their physical development and about the development of their mental game allows them to make more informed and beneficial decisions to improve various aspects of their performance and overall achievement throughout their career.

The inventions described enable communications between the players, coaches, managers, or trainer or other users of the system. For example coaches directly receive the messages preached by the coach and the workouts assigned by the coach. By giving coaches access to the messages communicated to the players in the past, and access to the workouts assigned, coaches can make a greater impact on their players in several ways. First, by giving coaches the opportunity to communicate with players more often, it will allow coaches to establish better relationships with players and to instill their confidence in players more readily. Second, by giving coaches immediate feedback on a player's status and performance, coaches can make better decisions when creating game rosters, workout routines and practice sessions. For example, in one embodiment of the invention, if a basketball player has missed 14 of his last 15 three point shots in the final two minutes of a game but is otherwise a high percentage shooter, coaches will be able to quickly review and assess this information. The coaches may utilize this information if the team is presented with a game situation when a three-point goal is required, and may ask one of his other players who is more confident at that time, or has a higher tendency for making a “clutch” shot. This information and assessment of data provided by the inventions result in more consistent decision-making by coaches, and also, a team winning more consistently.

Players can also communicate with coaches and other users, including collaborating with other players. Players may benefit significantly from their ability to communicate with coaches. Mainly, they receive immediate feedback and guidance from coaches. Additional, players may identify problems or issues on their own, and bring them to the attention of their coaches and managers. For example, players may also develop their own strategies for performing against their opponents and communicate those ideas to the coaches and team.

It should be noted that communication between players, coaches, trainers, administration, players, users, etc. can take several forms. Communication sent between users can be text-based messages. It can also be “data” messaging. This allows coaches and players to share information that they learned about while querying existing data. For example, in a baseball context, a pitcher learns through a location chart that he has been throwing fastballs inside every time he gets to a 3-ball and 2-strike pitch count with hitters, and is unsuccessful and beating hitters 80 percent of the time. The pitcher can send a query for advice from his pitching coach and include a text message indicating that he noticed his reliance on inside fastballs on 3-ball and 2-strike pitch counts. Communication can also be in the form of a forum, where team members can post and discuss topics about the team, which may for example, include a coach posting a message for the whole team, etc.

Another important aspect of the invention includes a user's ability to enter data through a calendar of events. For example, coaches, trainers, and staff members can schedule events for players on individual calendars, group calendars or team calendars. Individual team member and players can also schedule the events for themselves on their respective calendars. These events include workouts, games, nutrition plans, injury treatment plans, etc.

### BRIEF DESCRIPTION OF THE DRAWINGS

The drawings illustrate the design and utility of various embodiments of the invention:

FIG. 1 is a schematic representation of an exemplary embodiment of a system and method for integrating data and processes of a sports organization and of member players or athletes engaged in physical activities into a unified system on a computer network.

FIG. 2 is a block diagram illustrating components of an exemplary embodiment of a system and method for integrating data and processes of a sports organization and of member players or athletes engaged in physical activities into a unified system on a computer network.

FIG. 3 is a state diagram showing a protocol for viewing game data employed by an exemplary embodiment of a system and method for integrating data and processes of a sports organization and of member players or athletes engaged in physical activities into a unified system on a computer network.

FIG. 4 is a state diagram showing a protocol for entering game data employed by an exemplary embodiment of a system and method for integrating data and processes of a sports organization and of member players or athletes engaged in physical activities into a unified system on a computer network.

FIG. 5 is a state diagram showing a protocol for messaging employed by an exemplary embodiment of a system and method for integrating data and processes of a sports organization and of member players or athletes engaged in physical activities into a unified system on a computer network.

FIG. 6 is a state diagram showing a protocol for determining data access permissions employed by an exemplary embodiment of a system and method for integrating data and processes of a sports organization and of member players or athletes engaged in physical activities into a unified system on a computer network.

FIG. 7 is a state diagram showing a protocol for entering workout data employed by an exemplary embodiment of a system and method for integrating data and processes of a sports organization and of member players or athletes engaged in physical activities into a unified system on a computer network.

FIG. 8 is a state diagram showing a protocol for creating a workout employed by an exemplary embodiment of a system and method for integrating data and processes of a sports organization and of member players or athletes engaged in physical activities into a unified system on a computer network.

### DETAILED DESCRIPTION OF PREFERRED EMBODIMENTS OF THE INVENTION

Various embodiments of the invention are described hereinafter with reference to the figures. It should also be noted that the figures are only intended to facilitate the description of specific embodiments of the invention. The embodiments are not intended as an exhaustive description of the invention or as a limitation on the scope of the invention. In addition, an aspect described in conjunction with a particular embodiment of the invention is not necessarily limited to that embodiment and can be practiced in any other embodiment of the invention.

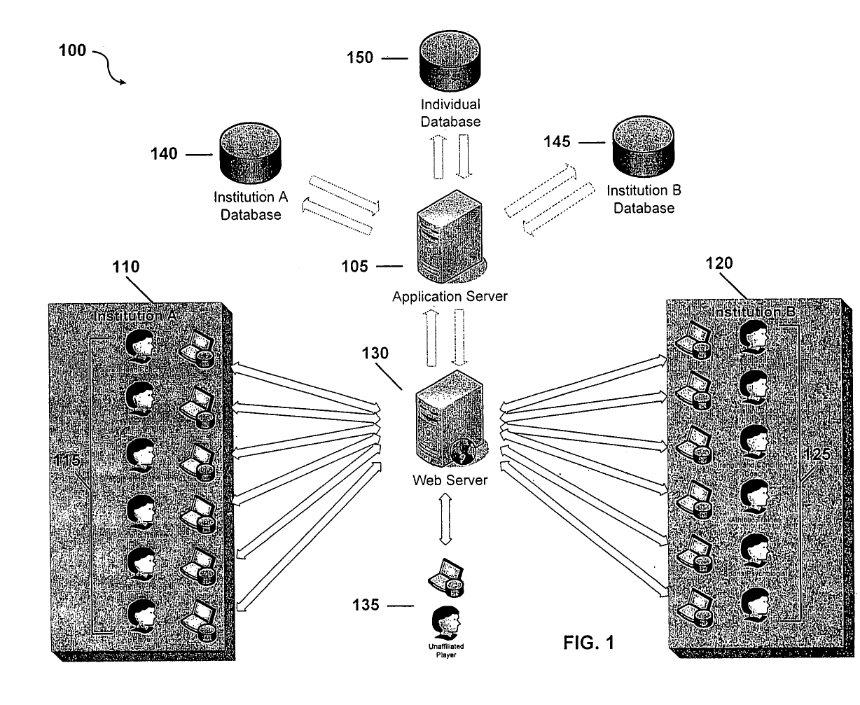

Turning now to the drawings, FIG. 1 is block diagram of a system 100, depicting a system for integrating data and processes of a sports organization and of member players or athletes engaged in physical activities into a unified system on a computer network in accordance with one embodiment of the present invention.

Referring to FIG. 1, system 100 comprises an application server 105, which provides logic and operations necessary for communication with institution “A” 110 and institution “B” 120, which may include sporting teams, institutions or organizations, and the individual members of institution “A”, users 115, and individual members of institution “B”, users 125. As an example, individual users 115 and 125 are listed in the diagram, which may include but are not limited to, a head coach, assistant coach, strength and conditioning coach, athletic trainer, sports psychologist, and the individual player or team athletes. Other users may include a sports doctor, nutritionist, and physical therapists, among others.

In addition, user 135 is an unaffiliated user, which may be a player unaffiliated with either institution “A” 110 or institution “B”, such as a statistician, unaffiliated scout, sports agent or off-season athlete in training. Users 115, 125 and 135 access data and reports from application server 105 via web server 130. Web server 130 hosts web services which may be accessed by users 115, 125 and 130 on their local devices. Data and messages are entered, updated, deleted and retrieved by users 115, 125 and 130 via the web services. In another embodiment of the invention, local devices may store an executable client application capable of accessing application server 105 directly via communications networks, such as the Internet. Further, local devices may include, but are not limited to, computers, laptops, tablet computers and other portable computers, including personal digital assistants, mobile and cellular phones, smart phones and other wired and wireless computing devices.

Application server 105 communicates with a separate database for each institution and/or individual. In this exemplary embodiment of the invention application server 105 stores data and communications from and between members of institution “A” 110 in institution “A” database 140, and data and communications from and between members of institution “B” 120 in institution “B” database 145. Similarly, should an administrator of application server 105 desire, each user's data and communications may be stored in an individual database 150. As shown in FIG. 1, unaffiliated user 135 data and communications will be stored in an individual database 150.

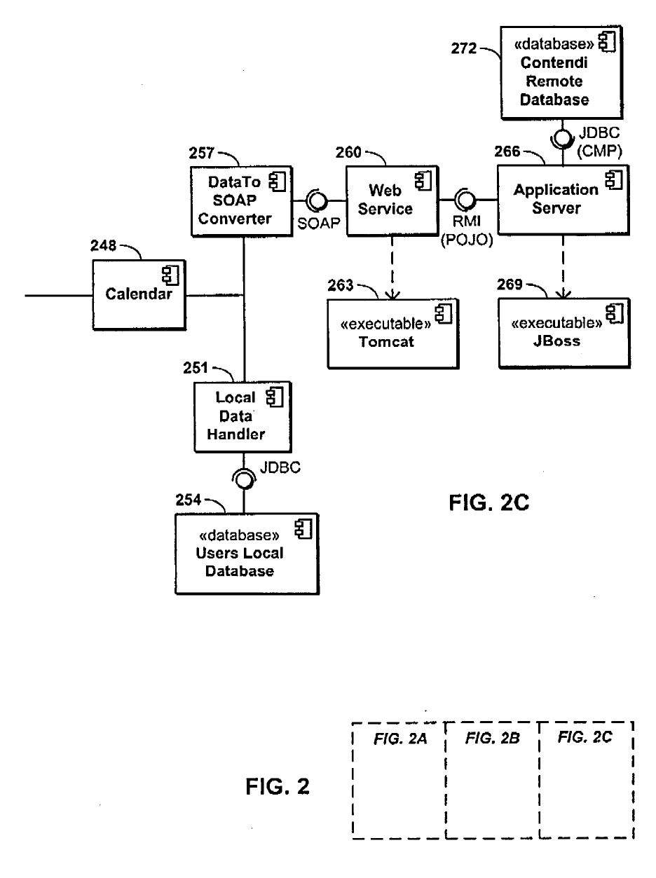

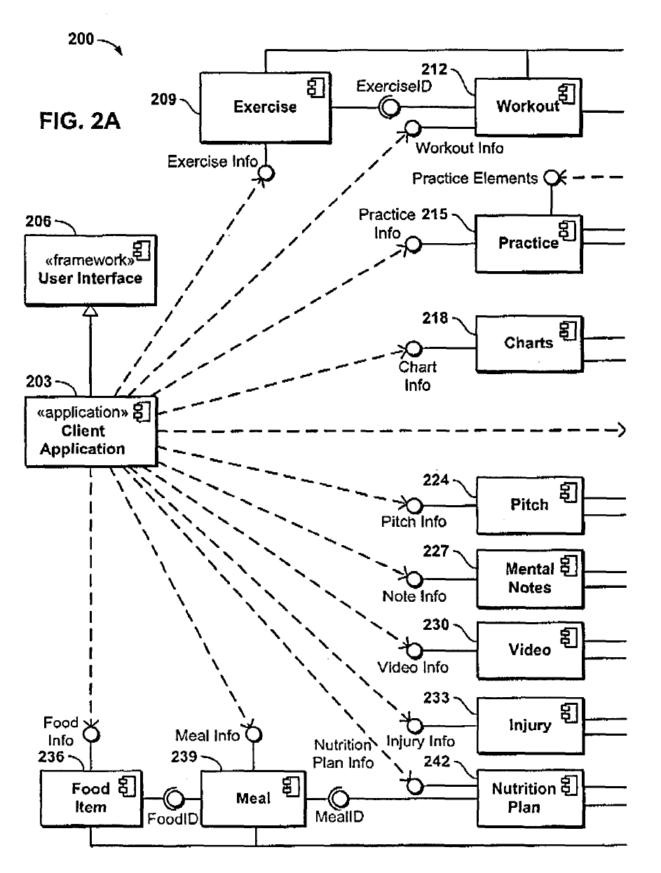

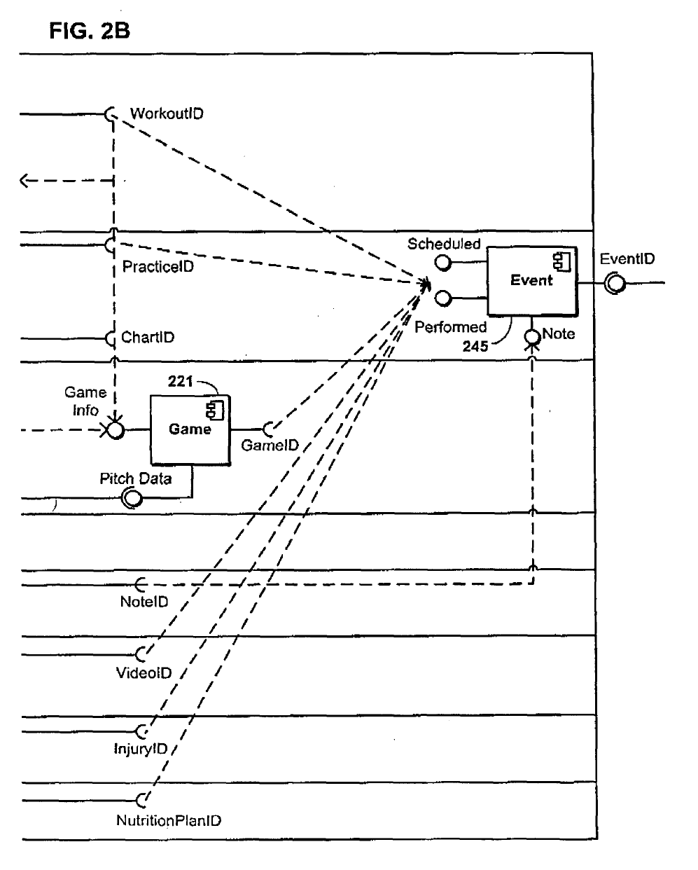

FIG. 2 is a block diagram illustrating components of an exemplary embodiment of a system and method for integrating data and processes of a sports organization and of member players or athletes engaged in physical activities into a unified system on a computer network.

Referring to FIG. 2, system 200 consists of four main sub-systems. These subsystems include client application 203 (shown in FIG. 2A), web application server 260 (shown in FIG. 2B), application server 266 (shown in FIG. 2B), and central database 272 (shown in FIG. 2B).

Client application 203 is the primary means of data input by users 115, 125 and 135. It may be located on a regular desktop computer, laptop computer, PDA or other mobile device. Each user may have one or more of the previously stated devices with client application 203 installed for sports data input.

Sports data (shown in FIG. 2A) includes but is not limited to, exercise data 209, workout data 212, practice data 215, charting data and charts 218, game data 221, pitch data 224 (specific to baseball statistical data), mental notes data 227, video data 230, injury data 233, food data 236, meal data 239, nutrition plan data 242, and event data 245. Additional information regarding the sports data types are described below.

Depending on the device that stores and runs client application 203, the device may contain a local database 254 or data store to store sports data via local data handler 251 related to the user or the user's team, organization, club, or school (i.e. data specific to institution “A” 110 or institution “B” 120). The sports data on client application 203 will be synchronized with the data stored on application server 266 both at the time the client is opened, and periodically throughout the time the program is open. Client application may be implemented in any computer language, including, but not limited to, Java, C, C++, C#, Objective-C, HTML, ASP, etc. and may be either standalone or web-based.

When client application 203 synchronizes data with, stores data to, or retrieves data from the central database 272 (located on application server 266), it first communicates with the web application server 260 via Simple Object Access Protocol (SOAP) messages as specified by W3C (http://www.w3.org/TR/soap/). Client application 203 may connect to the server directly, or connect to a private Universal Description Discovery and Integration (UDDI) entity that will point the client to the correct web service on web application server 260.

Web application server 260 may, for example, be Apache Tomcat 263, though any comparable application server used as a web service container may be used, including, but not limited to, IBM WebSphere, Oracle Application Server, Sun Application Server, BEA Weblogic Server, etc. In an exemplary embodiment of the invention, web application server 260 contains Apache Axis as its SOAP engine for SOAP message communication. These web services will be defined using Web Service Definition Language (WSDL) specification, and deployed to Apache Axis using Apache Axis WSDL2Java technology. Web application server 260 acts as a pipe for routing data traffic coming from various users 115, 125 and 135 to the correct Enterprise Java Beans (EJBs) on application server 266.

When web application server 260 receives a data request (synchronization, storage, or retrieval) from client application 203 and determines the correct EJB to access, it will communicate with that EJB (lying on web application server 260) via Remote Method Invocation (RMI) as specified by Sun Microsystems (http://java.sun.com/products/jdk/rmi/).

Application server 266, may, for example, be JBoss Application Server 269, though any comparable application server may be used, including, but not limited to, IBM WebSphere, Oracle Application Server, Sun Application Server, BEA Weblogic Server, etc. In an exemplary embodiment of the invention, application server 266 contains Enterprise Java Beans (EJBs), namely Session and Entity beans for computing business logic, and communicating with central database 272.

Communication between application server 266 and central database 272 may be handled through Container Managed Persistence (CMP) of the Entity beans located on application server 266.

Central database 272 may, for example, be MySQL, though any database may be used, including, but not limited to, any version of Oracle Database, PostgreSQL, Microsoft SQL Server, etc. Central database 272 may reside on the same server machine as application server 266 for easy communication between the Entity beans and the database.

While the description above refers to particular embodiments of the present invention, it will be understood that many modifications may be made without departing from the spirit thereof. Without modifying the architecture, there are several ways to structure and implement the system described herein. In one embodiment of the invention, data transmission policies between the client application 203 and the web application server 260 may be changed. Although SOAP has been described as the preferred transmission policy, other possible data transmission policies include, but are not limited to, direct TCP/IP connection with transmission through sockets (typical client-server model), communication via Remote Method Invocation (RMI), communication via RMI over Internet Inter-Orb Protocol (IIOP), communication via Common Object Request Broker Architecture (CORBA), or any combination of these.

In another embodiment of the invention, data transmission policies between the web application server 260 and the application server 266 may be changed. Although RMI has been described as the preferred transmission policy, other possible data transmission policies may include, but are not limited to, direct TCP/IP connection with transmission through sockets (typical client-server model), communication via Remote Method Invocation (RMI), communication via RMI over Internet Inter-Orb Protocol (IIOP), communication via Common Object Request Broker Architecture (CORBA), or any combination of these.

In another embodiment of the invention, data transmission policies between the application server 266 and the central database 272. Although CMP via EJB Entity beans has been described as the preferred transmission policy, other transmission policies include, but are not limited to, Bean Managed Persistence (BMP), Java Database Connectivity (JDBC) access, Open Database Connectivity (ODBC), etc.

In an exemplary embodiment of the invention, MySQL has been described as the preferred database, though many other possible databases can be used, including, but not limited to, Oracle Database, PostgreSQL, Microsoft SQL Server, etc. Data may also be stored in XML format. However, due to the amount of data that will be inputted and retrieved in this system, pure XML will create files that are extremely large and difficult to parse. The performance of the system may not be optimal as compared to a system using a typical database data store.

Implementations of the invention which include architectural modifications to the system are described below.

Central database 272 may be moved to a different physical server (i.e. stored on a separate machine) than the application server 266. This may lead to more modularity.

In another embodiment of the invention, web application server 260 may be removed. It is entirely possible to connect directly from client application 203 to application server 266. However, it must be noted that web application server 260 provides a crucial extraction layer between these two subsystems allowing client application 203 to find specific web services (via the UDDI) that they are communicating to and through. This capability provides cross-platform compatibility and enables easy integration with other software products.

In another embodiment of the invention, application server 266 may be removed. It is possible to handle communication directly from the web application server 260 to the central database 272. However, this method has several disadvantages because it forces significant amounts of logic to be placed inside web services, which may slow the system down. There may also be security concerns that arise in the direct transmission of data from the web application server 260 to central database 272.

In another embodiment of the invention, both the web application server 260 and the application server 266 may be removed from the system architecture. In such a configuration, client application 203 would connect directly to central database 272. However, this connection may require excessive amounts of logic on the client side, and may not be as extensible or maintainable as the exemplary embodiment.

As previously discussed, sports data may consist of, but is not limited to, exercise data 209, workout data 212, practice data 215, charting data and charts 218, game data 221, pitch data 224 (specific to baseball statistical data), mental notes data 227, video data 230, injury data 233, food data 236, meal data 239, nutrition plan data 242, and event data 245. Each of the sports data types are described below specifically with respect to baseball. It should be understood that the data types can be ascribed to a wide variety of sporting activities and athletic events.

Workout data 212 may include, but is not limited to, weightlifting workouts, cardio workouts, agility workouts, etc. Baseball workout data may include, but is not limited to, throwing workouts, hitting workouts, stretching workouts, and fielding workouts. Workouts can be thought of as a collection of exercises that are associated with that workout, and the exercise data 209 can be considered a subset of the workout data 212. The properties of exercise data 209 may include but is not limited to, sets, reps, and rest time for each exercise. For example, a weightlifting workout may consist of several weightlifting exercises including a “bench press” and “back squat” profile, including the number of sets, reps, and rest time between sets for each “bench press” and “back squat” exercise profile.

Practice data 215 may include, but is not limited to, data collected during team practices and meetings, such as the practice minutes (describing what events took place at what time during the practice), team preparedness (describing how well prepared certain coaches or athletes were for the practice), team focus (describing how focused was the team for practice), individual and team productivity (describing how productive the practice was, on an individual or team basis), etc. Practice data may be a container for other types of data, such as workout data. For example, a baseball practice may consist of a stretching workout from 3:00 PM to 3:15 PM, then concurrent throwing and hitting workouts from 3:15 PM to 4:00 PM. As another example, a coach may store practice data noting that the team seemed to be overly tired during a particular day's practice, further noting that an overnight bus-trip may have been the culprit.

Game charts 218 may include, but are not limited to, responsibility charts (describing each player's assignments and responsibilities before, during, and after the game), tendency charts (which may keep track of what situations opposing teams likes to steal, hit and run, bunt, etc.), and other data kept in tabular format.

Game data 221 may be comprised any combination of game statistics (i.e., statistics that are typically collected in baseball), video clips taken during the game, and charts taken during or after the game. For example, typical baseball statistics for pitchers include, but are not limited to, walks, strikeouts, earned run average, walks and hits per inning pitched, number of pitches thrown, etc. For hitters, statistics include, but are not limited to, hits, doubles, triples, home runs, batting average, slugging percentage, on base percentage, base on balls, etc. These statistics are typically measured in baseball on a pitch-by-pitch basis. As shown in FIG. 2A, pitch data 224 is a subset of game data 221.

Mental data 227 may include notes, reminders, or other data that allows users 115, 125 and 135 to store their mental state on a given date or for a given performance, including those of observers, including coaches and trainers. Mental data 227 may be organized to reflect the data as entries in a daily journal. For example, a pitcher has a very good or very poor outing and is able to record how he was feeling during the outing. As another example, a coach may have scolded a pitcher for his poor performance one day, and completes an entry regarding the player to keep track of the pitcher's reaction to it during his next outing.

Video data 230 may include video clips of any subject of interest recorded and entered by users 115, 125 and 135. Examples of video clips include, but are not limited to individual pitches or at-bats, an inning of a game (or any other sub-portion of game), or an entire day (which may be comprised of recorded workouts, practice sessions, pre-game walkthroughs, and 9 innings of baseball). Further, video data may be comprised of digital video clips that may focus on individuals (i.e. filming an individual pitcher, hitter, or fielder to record his mechanics) to be stored in an individual database 150, or on groups of individuals (i.e. filming the entire infield to see their movement on a bunt play) to be stored in institution databases 140 and 145.

Injury data 233 may include, but is not limited to, the nature, description, and location of the injury, the situation in which the injury took place, the planned treatment of the injury, the actual treatment of the injury, and any data associated with change in status of the injury.

Nutrition plan data 242 may include, but is not limited to, nutritional facts about certain food items or meals, and other data collected by users about the meals or foods that they or others have consumed or plan to consume. As shown in FIG. 2A, food item data 236 and meal data 239 are subsets of nutrition plan data 242.

Event data 245 consists of the combination of one or more types of schedulable data (i.e. data that can be assigned to a date and placed onto a calendar). Event data may be the “calendar event” representation of nutrition plans data, workouts data, game data, injury data, video data, practice data, and mental data. Event data captures these data types and assigns them to a day on a respective calendar. Event data may also consists of the “performed” representation of each of these data types. As an example, prior to the baseball season, in January, a coach may create all of the games that his/her team will play that season. Each of these games is represented as game datum, and each game datum is represented as an event datum (when it is assigned a date on a calendar). This event datum is referred to as “scheduled” event datum. In February, after playing the first game, the coach then enters “performed” event datum. Here, the coach enters the data for the event as it actually happens.

Event data is entered and calendared into calendar 248. Calendar 248 is a container for event data. In the data hierarchy, calendar is a container for event data. Event data contains one or more “other” (schedulable) data, which includes date and time data.

The modules discussed below represent only a selection of modules that may be implemented in an exemplary embodiment the system and method described herein. It should be understood that a technical programmer or consultant with ordinary skill in the art may implement additional modules or customized modules that are covered by the system and methods for integrating data and processes of a sports organization and of member players or athletes engaged in physical activities into a unified system on a computer network as described herein.

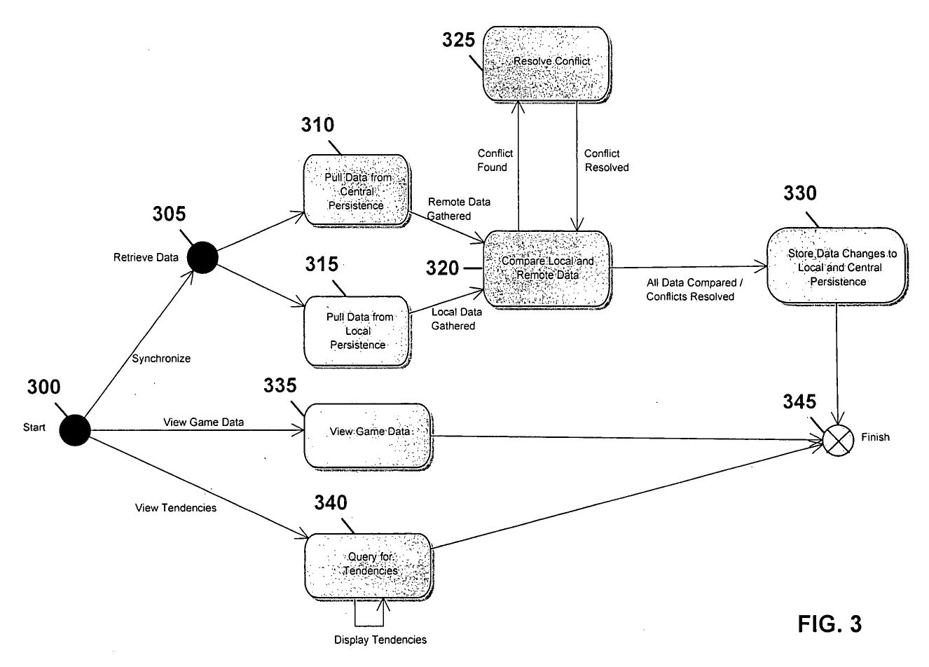

FIG. 3 is a state diagram showing a protocol for viewing game data employed by an exemplary embodiment of a system and method for integrating data and processes of a sports organization and of member players or athletes engaged in physical activities into a unified system on a computer network. From the idle start state 300, the user may transition from his current state by one of the three following actions: synchronize, view game data, and view tendencies. In many instances, the protocol requires the user to synchronize first before viewing game data to ensure the user has the most up-to-date game data and tendencies.

From start state 300, a user may synchronize with the Collaborative Sports Software (“CSS”) system viewing any shared data. For instance, after a game has been played, players may wish to view the statistics for that game. The synchronization protocol transitions to retrieve data state 305. To retrieve data, the CSS system transfers to state 310 and 315. In state 310, the data is pulled from the central persistence, database, or store. In state 315, the data is pulled from the local persistence, database, or store. When the data is gathered from both states 310 and 315, the CSS system transfer to state 320. In state 310, the local and remote data (from the central persistence, database or store) are compared. If a conflict is found, the CSS system transfers to state 325 to resolve the conflict. When all the data is compared and conflicts are resolved, the CSS system transitions to state 330. At state 330, any changes to the data are stored at both the local persistence and central persistence. At such point, a user will be able to synchronize with the CSS network and receive all the current game data, and transfers to idle finish state 345.

After the user synchronizes with the CSS system, the user is then able to view updated or old game data. The game data will be kept up-to-date by a complement of users charged with entering game data (e.g., the coaching staff, members of the team, a team statistician, etc.), After the synchronization protocol, which ensures the user has access to up-to-date game data, the user transitions from idle start state 300 to state 335 in order to view the game data. When the user has completed viewing the game data, the user transfers to idle finish state 345.

The CSS system utilizes all the entered sports data to predict player and team tendencies. Tendencies are the statistical projections and estimations which will be displayed in the CSS user interface. For example, if a pitcher wishes to see how well he pitches against particular teams or players, the pitcher could build a query for that particular tendency. When a user wishes to view tendencies, the user transitions from idle start state 300 to state 340. At state 340, the CSS system queries for tendencies. Tendencies charts and data are generated and are displayed. The more game data captured in the CSS system, the greater the usefulness and interest the tendencies will have to users. When the user has completed viewing tendencies, the user transfers to idle finish state 345.

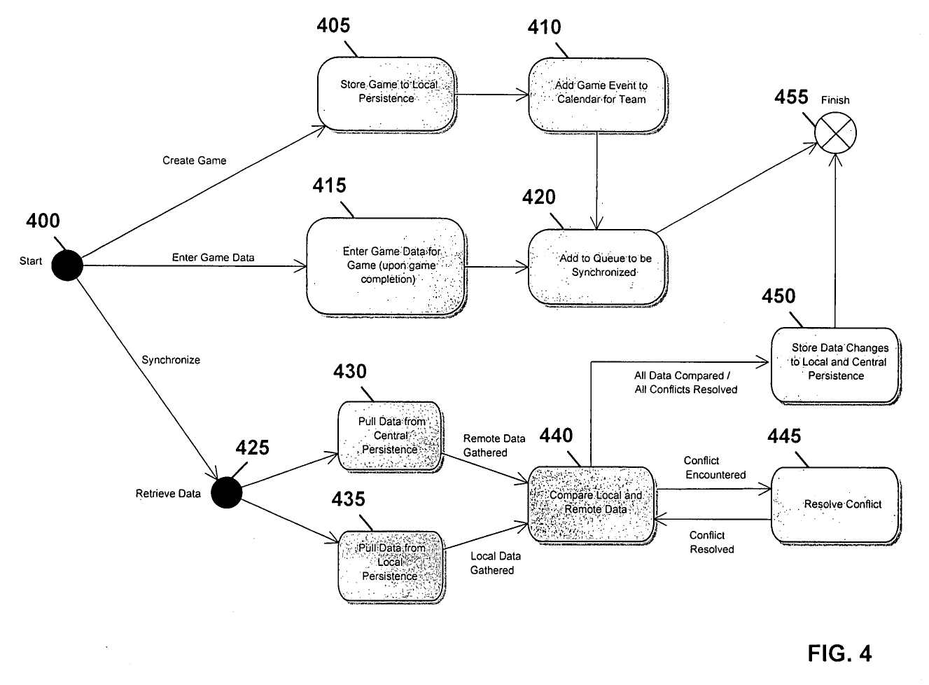

FIG. 4 is a state diagram showing a protocol for entering game data employed by an exemplary embodiment of a system and method for integrating data and processes of a sports organization and of member players or athletes engaged in physical activities into a unified system on a computer network. From the idle start state 400, the user may transition from his current state by one of the three following actions: create game, enter game data, and synchronize. From start state 400, a user may create a game event, and transfer to state 405, where the game event is stored to the local persistence, memory, or store. The game is added as an event to the team calendar at state 410. The CSS system transfers to state 420, where the game is added to the synchronization queue to be synchronized, and then transitions to idle finish state 455.

If a game event has already been created, the user may input game data for the event. The CSS system transitions to state 415, allowing a user to enter game data. Once entered, the game data is added to the synchronization queue to be synchronized at state 420, and then transitions to idle finish state 455. For example, to add information about a particular game, a user utilizes the client user interface provided by the CSS system to enter game data. Once finished, the game data will be added to the synch queue and will be there until the user chooses to synchronize or the CSS system automatically synchronizes the data.

In many instances. The protocol requires the user to synchronize with the CSS system after creating a game and then again after entering game data. For instance, after a coach creates a game, the coach will want to share the game with the rest of the team. The coach must synchronize with central persistence to share the game with the team. Then once the game is played, the coach will enter the game data and will need to synchronize once again to share the game data and results from that game. Conflicts will be resolved on the local machine and then the results of conflict resolution will be stored locally and remotely on the CSS system.

As shown in the state diagram, the synchronization protocol transitions from idle start state 400 to retrieve data state 425. To retrieve data, the CSS system transfers to state 430 and 435. In state 430, the data is pulled from the central persistence, database, or store. In state 435, the data is pulled from the local persistence, database, or store. When the data is gathered from both states 430 and 435, the CSS system transfers to state 440. In state 440, the local and remote data (from the central persistence, database or store) are compared. If a conflict is found, the CSS system transfers to state 445 to resolve the conflict. When all the data is compared and conflicts are resolved, the CSS system transitions to state 450. At state 450, any changes to the data are stored at both the local persistence and central persistence. At such point, a user will be able to synchronize with the CSS network and receive all the current game data, and transfers to idle finish state 455.

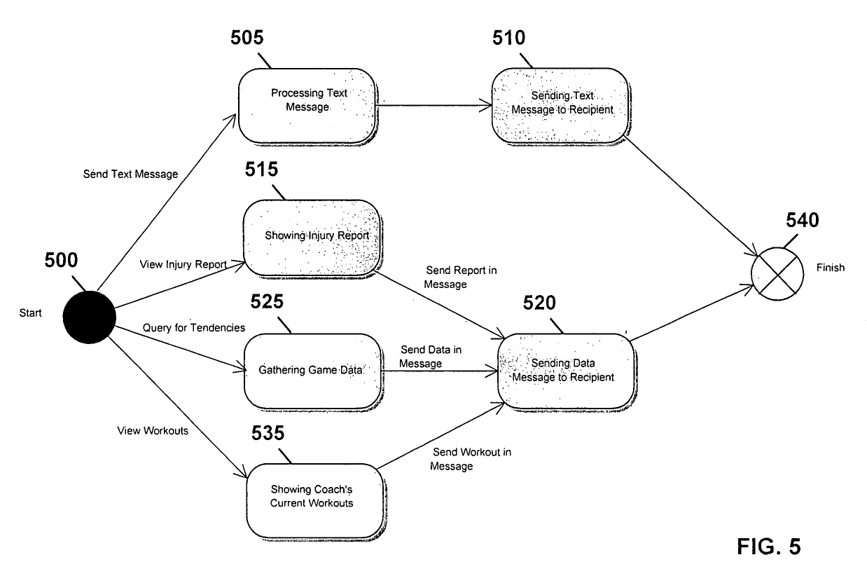

FIG. 5 is a state diagram showing a protocol for messaging employed by an exemplary embodiment of a system and method for integrating data and processes of a sports organization and of member players or athletes engaged in physical activities into a unified system on a computer network. The “Messaging” state diagram depicts some of the possible actions that a user may take to send a message to another user on their team. From idle start state 500, the user may transition from his current state by one of the two following actions: sending text messages and sending text messages containing data.

Text messages are simple messages sent instantaneously from the user that created the message to the user indicated as recipient of the message. From start state 500, a user may send a text message to another user using the CSS system. The messaging protocol transitions to processing text message state 505. After the message is processed, the CSS system transitions to state 510 to send the text message to the recipient. When the message is sent, the CSS system transfers to idle finish state 540.

There are only three scenarios for sending data messages in the state diagram in FIG. 5. However, any of the data types described herein may be shared with other users on the system. The data messaging feature allows users to exchange any data type retrieved by the CSS system. As shown in FIG. 5, users can share injury data, tendency findings from the game data, and workout information.

In order to send a data message, the user must select the data to be sent. From start state 500, the user may choose to view an injury report and transfers to state 515, where the injury report is displayed to the user. In another instance, the user may wish to query for tendencies, and transfers to state 525, where the game data is gathered, analyzed, tabulated and displayed by the CSS system in state. In another instance, the user may wish to view a workout assigned by a coach and transfers to state 535, where the coach's designed workout is displayed. After these initial actions are executed, the user may send the results to other users, along with a text message. From states 515, 525 and 535, messaging protocol transitions to sending the data message at state 520. When the message is sent, the CSS system transfers to idle finish state 540.

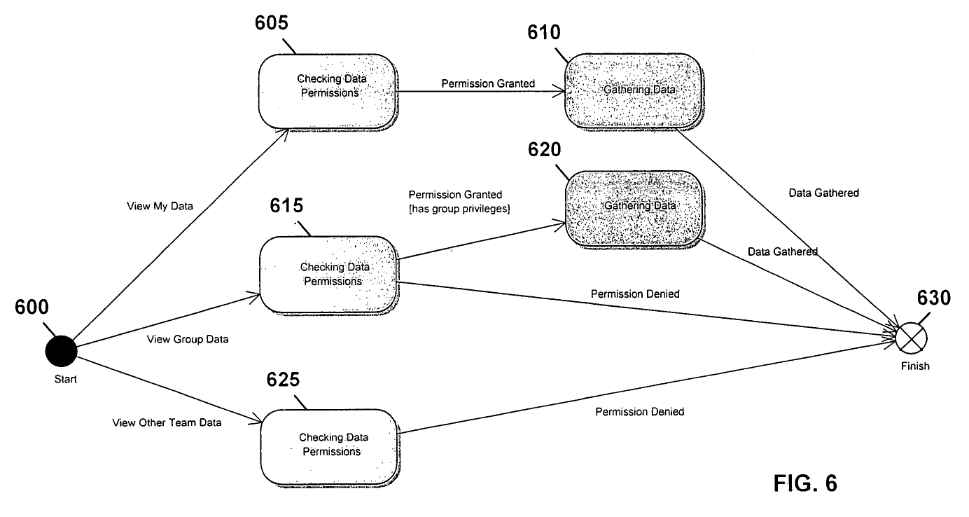

FIG. 6 is a state machine diagram showing a protocol for determining data access permissions employed by an exemplary embodiment of a system and method for integrating data and processes of a sports organization and of member players or athletes engaged in physical activities into a unified system on a computer network. From the idle start state 600, the user may transition from his current state by one of the three following actions: view my data, view group data, and view other team data. The state diagram is specific to a user of a team, as a member of a specific institution, for example, institution “A”.

From start state 600, a user may want to view the user's own data on the CSS system. The permissions protocol transitions to state 605, checking data permissions for the user. Typically, permission is always granted for each user for access privileges to data either input by the user or data others have created for the users viewing. To gather data, the CSS system transfers to state 610. When the appropriate data is gathered, the user may access the data, and transfers to idle finish state 630.

A user may request to view group data that is made public by other members of the CSS system. The permissions protocol transitions from start state 600 to state 615, where data permissions are checked. Typically, data not created by a user may only be read, not modified or deleted. Therefore, privileges are determined based upon the permissions tag associated with the data. For example, in baseball, the user may be a shortstop. Group data may include “team data” for all users and players, “pitcher data” for pitchers, “outfielder data” for outfielders, “infielder data” for infielders including the user who plays shortstop. If data is private, this user will not be able to view it. Permission is denied to the user, and permissions protocol is transferred to finish state 630. If the data is public or the user has privileges for the group, the user is granted permission to view the group data. To gather data, the CSS system transfers to state 620. When the appropriate data is gathered, the user may access the data, and transfers to idle finish state 630.

When determining write privileges, the CSS system will only allow certain types or categories of users the privilege to modify or delete data created by another user. These users will only have this privilege in situations granted by the CSS system administrator or team administrator user (e.g., the Head Coach, Manager, or Athletic Director). For example, a coach may be granted permission to modify or delete the data in a game that another coach has created. However, a player may not modify or delete the data in a game that a coach has created.

The CSS system provides a robust permissions and security protocols to prevent unauthorized access. For example, the user, as a team member of institution “A”, may request to view the team data from an opposing team at institution “B”. The permissions protocol transitions from start state 600 to state 625, where data permissions are checked. Typically, each team will be “firewalled” off from other teams. Access to another team's data will be tightly controlled by the CSS system, and will only be given with the authority of each team's administrator user. In this instance, the user is a team member of another institution, and permission is denied to the user. Permissions protocol transfers to finish state 630.

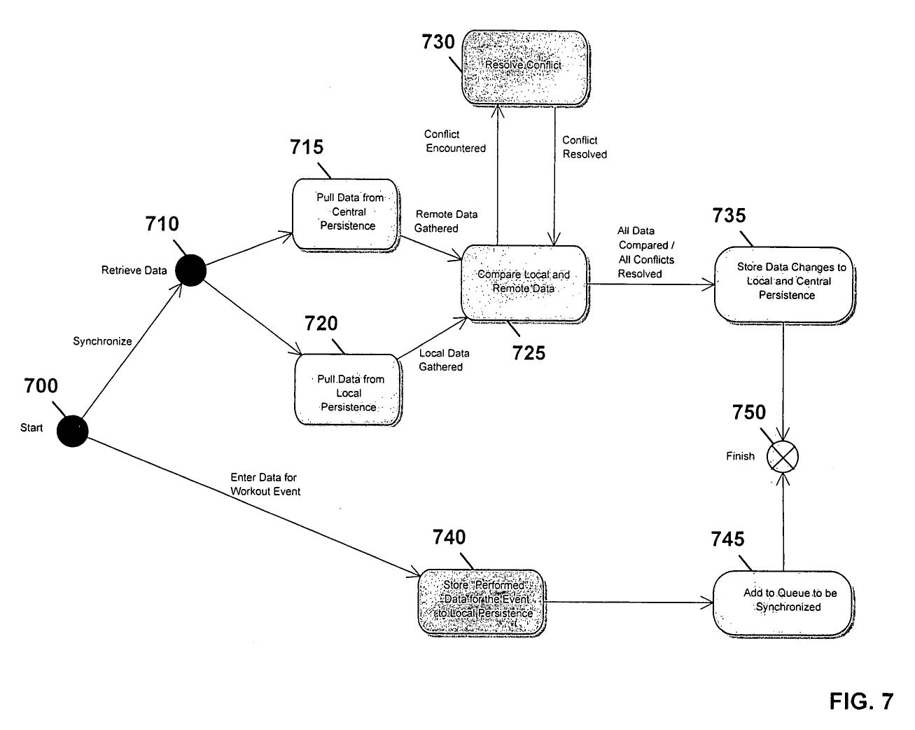

FIG. 7 is a state machine diagram showing a protocol for entering workout data employed by an exemplary embodiment of a system and method for integrating data and processes of a sports organization and of member players or athletes engaged in physical activities into a unified system on a computer network. From the idle start state 700, the user may transition from his current state by one of the two following actions: enter workout data and synchronize.

Users may utilize the CSS system's ability to track performance and workout history. By allowing the end user to enter workout data for performed workouts, the CSS system can also track a historical record of practices and workouts.

The CSS System allows a user to enter data for a workout given two conditions. First, the workout must be scheduled to a calendar that the user is associated with. Second, the scheduled workout date and time must be prior to the current time, as a user should not be allowed to record workout data for a workout that has not yet been performed. Workout data may take the form of performed repetitions and weights for a weightlifting workout. The user may also enter notes for the workout.

As shown in FIG. 7, from start state 700, a user may enter data for a workout event, and transfer to state 740, where the workout event, once performed by the user, is stored as to the local persistence, memory, or store. Once the workout data has been entered and saved, the local system must post this information to the central team server. This information will be placed on a queue to be synchronized with the server. The CSS system transfers to state 745, where the game is added to the synchronization queue to be synchronized, and then transitions to idle finish state 750.

From start state 700, a user may synchronize with the CSS system after enter data for a workout event. For instance, after a workout is performed, players may wish to update their coach that the workout as scheduled has been complete to get new assigned workouts. The synchronization protocol transitions to retrieve data state 710. To retrieve data, the CSS system transfers to state 715 and 720. In state 715, the data is pulled from the central persistence, database, or store. In state 720, the data is pulled from the local persistence, database, or store. When the data is gathered from both states 715 and 720, the CSS system transfer to state 725. In state 725, the local and remote data (from the central persistence, database or store) are compared. If a conflict is found, the CSS system transfers to state 730 to resolve the conflict. When all the data is compared and conflicts are resolved, the CSS system transitions to state 735. At state 735, any changes to the data are stored at both the local persistence and central persistence. At such point, a user will be able to synchronize with the CSS network and receive all the current game data, and transfers to idle finish state 750.

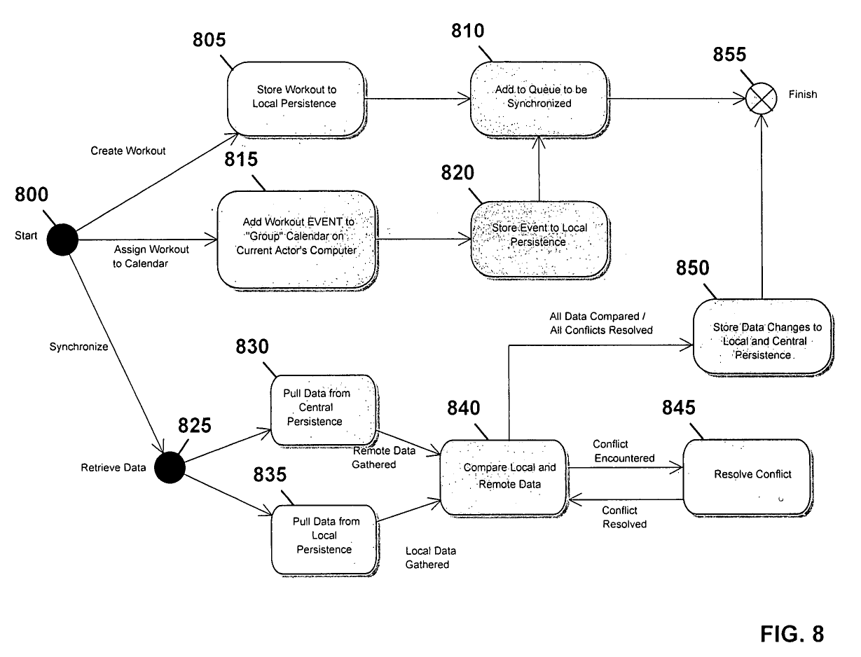

FIG. 8 is a state machine diagram showing a protocol for creating a workout employed by an exemplary embodiment of a system and method for integrating data and processes of a sports organization and of member players or athletes engaged in physical activities into a unified system on a computer network. From the idle start state 800, the user may transition from his current state by one of the three following actions: create workout, assign workout to the calendar, and synchronize. From start state 800, a user may create a workout and transfer to state 805, where the workout is stored to the local persistence, memory, or store. The CSS system transfers to state 810, where the game is added to the synchronization queue to be synchronized, and then transitions to idle finish state 855.

If a workout has already been created, the user may want to assign the workout to a group calendar, for many users (i.e. specific individuals on a team). The CSS system transitions to state 815, allowing a user to add the workout event to a calendar for an entire group and on the calendar of each member in the group, in addition to the user's calendar. The workout event is stored to the local persistence, memory, or store at state 820. Once stored, the game data is added to the synchronization queue to be synchronized at state 810, and then transitions to idle finish state 855.

For example, a pitching coach may create a throwing workout that contains throwing exercises like bullpens and warm-ups. Once the exercises for the workout are selected, the pitching coach can then choose to assign the workout to a calendar. The pitching coach may assign the workout to a group calendar for all pitchers on the team. On the other hand, players may have the ability to assign a workout to their own individual calendars.

Once the workout has been created and saved, the local system must post this information to the central team server. Likewise, if the workout has been assigned to a calendar, then the updates to the calendar must also be posted to the server. This information will be placed on a queue to be synchronized with the server.

In many instances, the protocol requires the user to synchronize with the CSS system after creating a workout and again, after assigning the workout event to a calendar. As shown in the state diagram, the synchronization protocol transitions from idle start state 400 to retrieve data state 825. To retrieve data, the CSS system transfers to state 830 and 835. In state 830, the data is pulled from the central persistence, database, or store. In state 835, the data is pulled from the local persistence, database, or store. When the data is gathered from both states 830 and 835, the CSS system transfers to state 840. In state 840, the local and remote data (from the central persistence, database or store) are compared. If a conflict is encountered, the CSS system transfers to state 845 to resolve the conflict. When all the data is compared and conflicts are resolved, the CSS system transitions to state 850. At state 850, any changes to the data are stored at both the local persistence and central persistence. At such point, a user will be able to synchronize with the CSS network and receive all the current game data, and transfers to idle finish state 855.

Synchronization is typically initiated by the client application located at the local device. When attempting to post updates to the server, the client application first determines if the updates will cause any conflicts. This is done by downloading the changes in data identified at the application server and comparing them to changes made on the client application. For example, a conflict could involve two coaches modifying the name of a workout. Once conflict resolution is performed, data is stored at the local persistence, memory, or store and is also stored at the central database, persistence, memory or store.

In addition to basic tendency information, the CSS system may also provide users with advanced simulation modeling that, over extended periods of data collection, help to determine expected future behavior and state. This would be done by collecting current state data (including workout, game, nutrition, injury, mental health, and other data) and assigning each of them to a random variable that fits a distribution curve. Over an extended period of time, with subsequent increase in data, the system would be able to predict future player behavior and state within some confidence interval based upon the curve. These predictions may include, but are not limited to, determining the expected hours of practice over the upcoming week, determining the expected weight gain/loss of a player over a given period of time, and establishing the expected number of workouts necessary each week to win a game. Each prediction given will give coaches and players a better understanding of what makes them or their team successful.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A system for integrating sports data on a computer network comprising:
a networked server capable of storing at least one of the following sports data: workout data, practice data, game statistics, calendar data, mental notes data, video data, injury data, and nutrition plan data;
a networked local device capable of accessing said networked server and capable of storing of storing at least one of the following sports data: workout data, practice data, game statistics, calendar data, mental notes data, video data, injury data, and nutrition plan data; and
an application capable of executing at least one of the following customized modules:
a module for entering sports data at said networked server store;
a module for entering sports data at said networked local device;
a module for synchronizing said sports data between said networked server and said networked local device; and
a module for messaging said sports data from a first user to a second user.

2. The system of claim 1, wherein said application resides at said networked server.

3. The system of claim 1, wherein said application resides at said networked local device.

4. The system of claim 1, wherein said application is further capable of executing a module for generating tendency data.

5. The system of claim 1, wherein said application is further capable of executing a module for simulation modeling.

6. The system of claim 1, wherein the network is a wide area network.

7. The system of claim 6, wherein the wide area network is the Internet

8. A system for integrating sports data on a computer network comprising:
a networked server capable of storing at least one of the following sports data: workout data, practice data, game statistics, calendar data, mental notes data, video data, injury data, and nutrition plan data;
a networked web server capable of hosting web services with access to said networked server;
a portable client device capable of accessing said networked web server; and
an application residing on said portable client device capable of executing at least one of the following customized modules:
a module for entering sports data at a said portable client device;
a module for synchronizing said sports data entered at said portable client device with said sports data at said networked server; and
a module for messaging said sports data entered at said portable client device.

9. The system of claim 1, wherein said application is further capable of executing a module for generating tendency data.

10. The system of claim 1, wherein said application is further capable of executing a module for simulation modeling.

11. The system of claim 1, wherein the network is a wide area network.

12. The system of claim 6, wherein the wide area network is the Internet

13. In a networked computing system including at least two networked devices connected via a wide-area network, a method for integrating sports data on a computer network, comprising:
entering sports data in at least one of the networked devices;
establishing a coordinated database of said sports data at each of said networked devices;
synchronizing said sports data between said networked devices; and
providing real-time communication of said sports data between a first user and a second user on said computer network.

14. The system of claim 13 further comprising:
enabling secure access to said coordinated database.

15. The system of claim 13, Her comprising:
calculating player and team tendencies.

16. The system of claim 13, further comprising:
performing simulation modeling from said sports data.

17. The system of claim 13, further comprising:
providing privileged access to said coordinated database to a select set of users.

18. The system of claim 13 wherein said coordinated database provides calendaring functionality.

19. The system of claim 13, wherein one of the at least two networked devices is one member selected from the following group: a desktop computer, a notebook computer, a tablet computer, a personal digital assistant, a mobile phone, a cellular phone, and a smart phone.
